(19) United States
(12) Patent Application Publication
(10) Pub. No.: US 2005/0133321 A1
(43) Pub. Date: Jun. 23, 2005

(54) Automotive stabilizer incorporated with suspension system

(75) Inventors: Shinsuke Fujishima, Kanagawa (JP); Yoshihiro Kawabe, Kanagawa (JP)

Correspondence Address: FOLEY AND LARDNER;SUITE 500, 3000 K STREET NW, WASHINGTON, DC, 20007, US

(73) Assignee: NISSAN MOTOR CO., LTD.

(21) Appl. No.: 11/004,874

(22) Filed: Dec. 7, 2004

(30) Foreign Application Priority Data
Dec. 17, 2003 (JP) 2003-419688

(51) Int. Cl. B60G 17/005; B60G 21/05

(52) U.S. Cl. 188/313; 280/124.106; 280/5.507

(57) ABSTRACT

An antisway bar extends transversely relative to a vehicle body. The antisway bar includes a pair of arm portions and a torsion portion extending between the arm portions. A pivot member is pivotally connected to a junction portion between the torsion portion and selected one of the arm portions. A link lever extends from the pivot member. A cylinder device includes a cylindrical case and a piston slidably received in the cylindrical case. The cylindrical case is connected to one of the selected arm portion and the link lever, and the piston is connected to the other of the selected arm portion and the link lever. A control system is provided to restrict the movement of the piston in the cylindrical case when actuated.

### BACKGROUND OF THE INVENTION

1. Field of the Invention

The present invention relates in general to automotive stabilizers and more particularly to the automotive stabilizers of a type that is incorporated with a suspension system to provide the vehicle with a stabilized driving behavior.

2. Description of the Related Art

In independent suspension systems of wheeled motor vehicles, stabilizers are widely used for providing the vehicles with a stabilizing effect during turning and cornering. Most stabilizers are of a type that, for controlling rolling of the vehicle body at turning and cornering, uses practically a torsional rigidity of an antisway or torsion bar. However, due to the nature of the stabilizers of such type, when the vehicle is running straightly on a bumpy road, the relative displacement (or motion) of right and left suspension arms is restricted and thus the impact absorption effect of the suspension system itself becomes lowered, which deteriorates the drivability of the vehicle.

In view of the undesirability of the stabilizers of such type, Japanese Laid-open Patent Application (Tokkaihei) 5-32115 proposes to make the rolling restricting function of the stabilizer ON/OFF selectively in accordance with a running condition of the vehicle.

In order to clarify the task of the present invention, the stabilizer of the publication will be briefly discussed with reference to FIGS. 12, 13 and 14 of the accompanying drawings.

As is seen from FIG. 12, the stabilizer of the publication generally comprises an antisway bar 102 that extends transversely relative to a vehicle body and an ON/OFF switch mechanism 103 that switches ON/OFF operation of antisway bar 102. Antisway bar 102 comprises a pair of arm portions 106 and 107 and a torsion portion 108 extending between arm portions 106. Torsion portion 108 is supported by the vehicle body through a bracket (not shown) that has a rubber bush installed therein. Arm portion 106 is pivotally connected to a con'rod 140 through a coupling 141, and con'rod 140 is vertically movably connected to a lower arm 109 of the suspension structure through ON/OFF switch mechanism 103. The other arm portion 107 is connected to the other lower arm. To assume ON condition, ON/OFF switch mechanism 103 fixes con'rod 140 to lower arm 109, and to assume OFF condition, the switch mechanism 103 releases con'rod from lower arm 109.

As is seen from FIGS. 13 and 14, ON/OFF switch mechanism 103 comprises a pair of recesses 155 and 156 formed in diametrically opposed portions of a generally middle part 157 of con'rod 140. ON/OFF switch mechanism 103 further comprises a pair of lock pieces 171 and 172 that are selectively engaged and disengaged with and from recesses 155 and 156 of con'rod 140. The selective engagement/disengagement of lock pieces 171 and 172 is controlled by a drive mechanism 180. That is, when, due to work of drive mechanism 180, lock pieces 171 and 172 are brought into engagement with recesses 155 and 156, a vertical movement of con'rod 140 relative to lower arm 109 (see FIG. 12) is prevented thereby to induce ON condition of the switch mechanism 103, while, when lock pieces 171 and 172 are disengaged from recesses 155 and 156, the vertical movement of con'rod 140 is permitted thereby to induce OFF condition of switch mechanism 103.

### SUMMARY OF THE INVENTION

However, due to its inherent construction, even the stabilizer of the publication has some drawbacks which are as follows.

That is, even when ON condition is needed by switch mechanism 103 under turning or cornering of the associated motor vehicle, such ON condition is not practically established if the position of recesses 155 and 156 of con'rod 140 does not coincide with that of lock pieces 171 and 172. Furthermore, even if such position coincidence is nearly made due to the sloped construction of recesses 155 and 156, a greater force is needed by drive mechanism 180 to achieve a tight connection between lock pieces 171 and 172 and recesses 155 and 156, which causes increase in cost and size of drive mechanism 180.

Accordingly, it is an object of the present invention to provide an automotive stabilizer incorporated with a suspension system, which is free of the above-mentioned drawbacks.

According to the present invention, there is provided an automotive stabilizer incorporated with a suspension system, which can assuredly control the rolling restricting function thereof in ON/OFF manner even under turning or cornering of an associated motor vehicle.

According to the present invention, there is further provided an automotive stabilizer incorporated with a suspension system, which can effect the control of the rolling restricting function with a compact drive means.

In accordance with a first aspect of the present invention, there is provided an automotive stabilizer incorporated with a suspension system, which comprises an antisway bar adapted to extend transversely relative to a vehicle body, the antisway bar including a pair of arm portions and a torsion portion extending between the arm portions; a pivot member pivotally connected to a junction portion between the torsion portion and selected one of the arm portions; a link lever extending from the pivot member; a cylinder device including a cylindrical case and a piston slidably received in the cylindrical case, the cylindrical case being connected to one of the selected arm portion and the link lever and the piston being connected to the other of the selected arm portion and the link lever; and a control system that restricts the movement of the piston in the cylindrical case when actuated.

In accordance with a second aspect of the present invention, there is provided an automotive stabilizer incorporated with a suspension system, which comprises an antisway bar adapted to extend transversely relative to a vehicle body, the antisway bar including a pair of arm portions and a torsion portion extending between the arm portions; a pivot member pivotally connected to a junction portion between the torsion portion and selected one of the arm portions; a link lever extending from the pivot member; a cylinder device including a cylindrical case, a piston slidably received in the cylindrical case and a piston rod extending from the piston to the outside of the cylindrical case, the cylindrical case having therein first and second work chambers that are isolated by the piston; a first pivot member through which the cylindrical case of the cylinder device is pivotally connected to a part of the selected arm portion; a second pivot member through which the piston rod is pivotally connected to the link lever; and an ON/OFF switch circuit that is able to selectively provide an opening condition to communicate the first and second work chambers and a closed condition to isolate the first and second work chambers.

In accordance with a third aspect of the present invention, there is provided an automotive stabilizer incorporated with a suspension system, which comprises an antisway bar adapted to extend transversely relative to a vehicle body, the antisway bar including a pair of arm portions and a torsion portion extending between the arm portions; a pivot member pivotally connected to a junction portion between the torsion portion and selected one of the arm portions; a link lever extending from the pivot member; a cylinder device including a cylindrical case, a piston slidably received in the cylindrical case and a piston rod extending from the piston to the outside of the cylindrical case, the cylindrical case having therein first and second work chambers that are isolated by the piston; an outer cylindrical case slidably disposed on the cylindrical case to define between a third work chamber; an accumulator; a first pivot member through which the outer cylindrical case is pivotally connected to a part of the selected arm portion; a second pivot member through which the piston rod is pivotally connected to the link lever; and an electromagnetic control valve unit that is able to provide three operation conditions which are a first condition wherein the first and second work chambers are connected and the third work chamber and the accumulator are disconnected, a second condition wherein the first and second word chambers are disconnected and the third work chamber and the accumulator are connected, and a third condition wherein the first and second work chambers are disconnected and the third work chamber and the accumulator are disconnected.

### BRIEF DESCRIPTION OF THE DRAWINGS

FIG. 1 is a schematic view of an automotive stabilizer incorporated with a suspension system, which is a first embodiment of the present invention;

FIGS. 2A, 2B and 2C are schematic views taken from the direction of the arrow “F” of FIG. 1, showing various operation conditions of the stabilizer of the first embodiment;

FIGS. 3A, 3B and 3C are additional schematic views taken from the direction of the arrow “F” of FIG. 1, showing also operation conditions of the stabilizer of the first embodiment;

FIG. 4 is a schematic view of a control system employed in the stabilizer of the first embodiment, which includes a cylinder device and an electromagnetic ON/OFF valve;

FIG. 5 is a view similar to FIG. 4, but showing an control system employed in a stabilizer of a second embodiment of the present invention;

FIG. 6 is a view similar to FIG. 4, but showing a control system employed in a stabilizer of a third embodiment of the present invention;

FIG. 7 is a partial view of a cylinder device employed in the control system of FIG. 6, showing the detail of a structure through which an end of a coil spring is connected to a piston;

FIGS. 8A, 8B and 8C are partial views of a cylinder device employed in the control system of FIG. 6, showing the detail of another structure through which the end of the coil spring is connected to the piston;

FIG. 9 is a view similar to FIG. 4, but showing a control system employed in a stabilizer of a fourth embodiment of the present invention;

FIG. 10 is a view similar to FIG. 4, but showing a control system employed in a stabilizer of a fifth embodiment of the present invention;

FIGS. 11A, 11B and 11C are sectional views of a control valve unit employed in the stabilizer of the fifth embodiment, showing different operation conditions thereof respectively;

FIG. 12 is a perspective view of a stabilizer of a related art employed in an automotive suspension system;

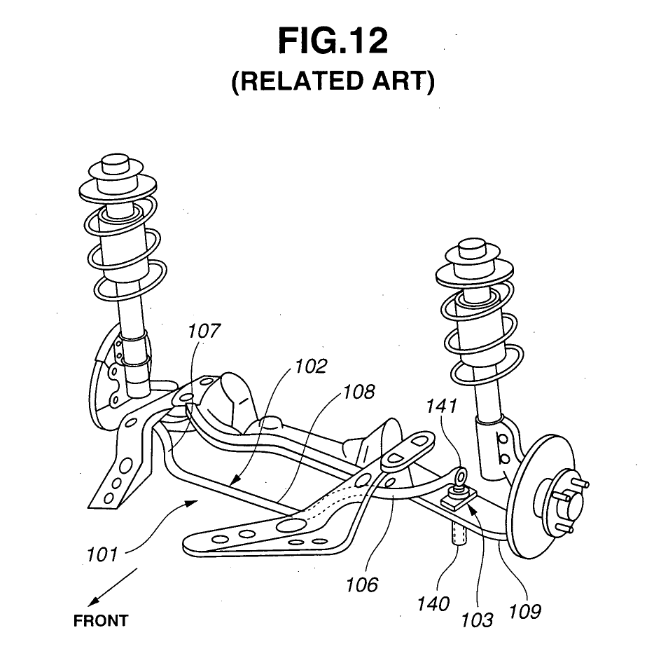

FIG. 13 is an exploded view of an ON/OFF switch mechanism employed in the stabilizer of the related art; and

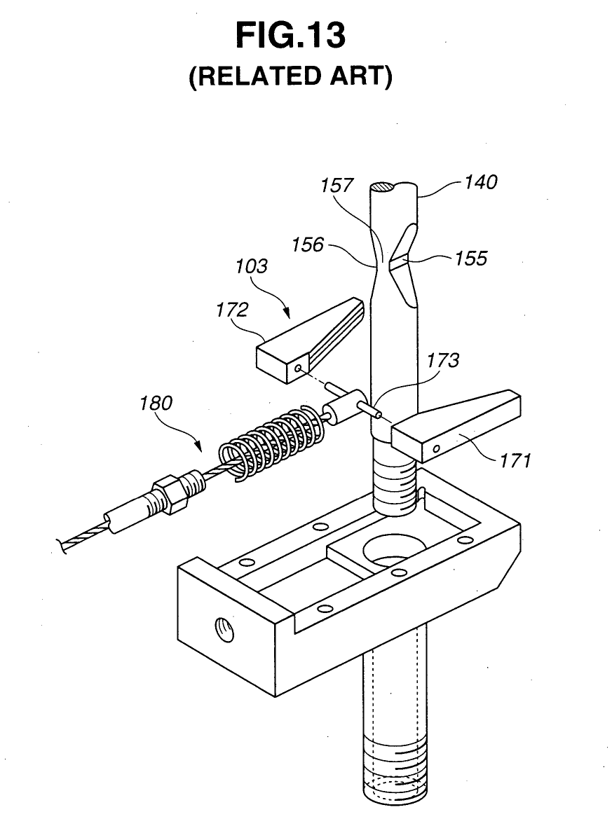

FIG. 14 is a sectional view of the ON/OFF switch mechanism of the stabilizer of the related art.

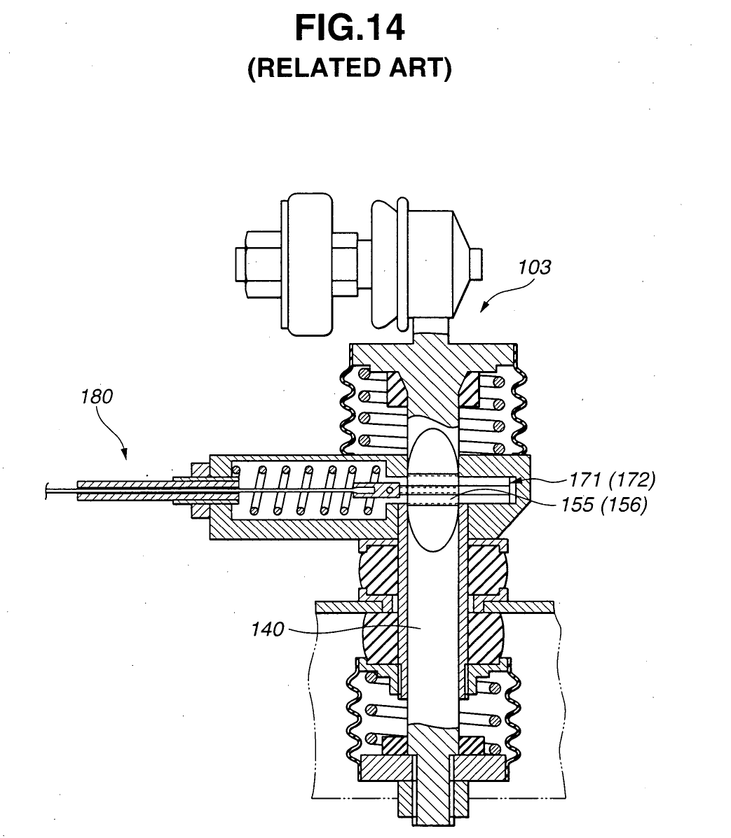

### DETAILED DESCRIPTION OF THE EMBODIMENTS

In the following, various embodiments of the present invention will be described in detail with reference to the accompanying drawings.

For ease of understanding, various directional terms, such as, right, left, upper, lower, rightward and the like are used in the following description. However, such terms are to be understood with respect to a drawing or drawings on which corresponding part or portion is shown.

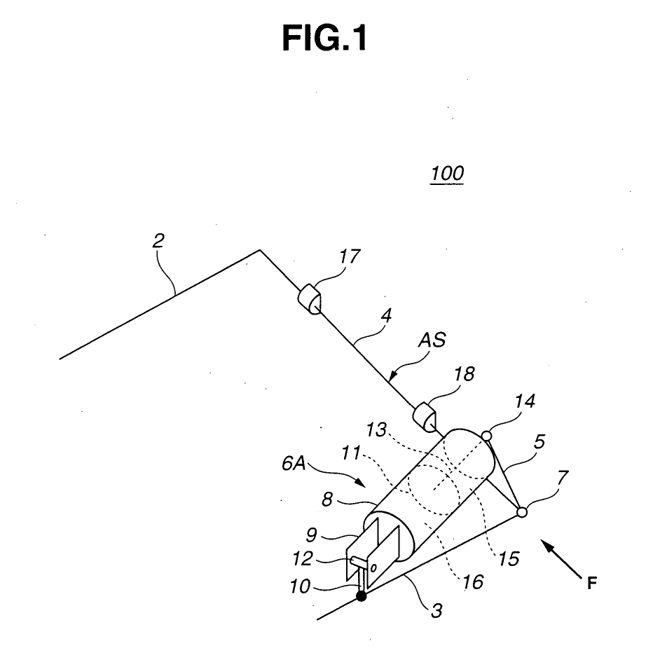

Referring to FIGS. 1 to 4 of the drawings, particularly FIG. 1, there is schematically shown an automotive stabilizer 100 incorporated with a suspension system, which is a first embodiment of the present invention.

As is seen from FIG. 1, automotive stabilizer 100 comprises an antisway bar “AS” that extends transversely relative to an associated motor vehicle. Antisway bar “AS” includes axially opposed arm portions 2 and 3 and a torsion portion 4 extending between arm portions 2 and 3.

Torsion portion 4 is pivotally supported by a body of the associated motor vehicle through brackets (not shown) that have rubber bushes 17 and 18 installed therein, and arm portions 2 and 3 are connected to lower arms (not shown) of the suspension system.

At a junction part between torsion portion 4 and arm portion 3, there is provided a pivotal bearing 7 from which a link lever 5 extends to a cylinder device 6A. As shown, between link lever 5 and arm portion 3, there extends the cylinder device 6A, thereby to constitute a so-called link mechanism.

That is, arm portion 3 is integrally connected to torsion portion 4 in a manner to pivot about the junction part between torsion portion 4 and arm portion 3 in an imaginary plane that is perpendicular to an axis of torsion portion 4.

In the link mechanism, cylinder device 6A comprises a cylindrical case 8 and a piston 11 slidably received in case 8. Case 8 is equipped at one end thereof with a bracket 9 by which a shaft 12 is pivotally held. Shaft 12 is equipped with a lever 10 of which leading end is fixed to arm portion 3. Thus, one end of case 8 is pivotally connected to arm portion 3. A piston rod 13 extending from piston 11 is pivotally connected to link lever 5 through a pivot member 14. With this arrangement, arm portion 3 is pivotal about the axis of torsion portion 4 in the imaginary plane, as is mentioned hereinabove.

The interior of cylindrical case 8 is divided by piston 11 into first and second work chambers 15 and 16 which are positioned at the sides of bracket 9 and pivot member 14 respectively.

As will be described in detail hereinafter, first and second work chambers 15 and 16 are connected through a control system.

When, in operation, the vehicle is subjected to a rolling due to running on a corner, the paired arm portions 2 and 3 produce therebetween a relative displacement (or motion) in a direction about the axis of torsion portion 4. However, in the present invention, even if such relative displacement is present, the rolling restricting function of the stabilizer 100 can be controlled is ON or OFF by the Control system irrespective of the degree of relative displacement. That is, if the rolling restricting function is not needed by the stabilizer 100, the Control system is tuned to assume an open condition. With this, two chambers 15 and 16 become communicated to induce a free flow of hydraulic fluid between two chambers 15 and 16. Thus, piston 11 of cylinder device 6A is permitted to move freely thereby allowing both torsion portion 4 and arm portion 3 to make a relative pivoting therebetween. While, if the rolling restricting function is needed by stabilizer 100, the Control system is turned to assume a close condition. With this, two chambers 15 and 16 become isolated from one another to interrupt the free flow of the fluid between two chambers 15 and 16, and thus the free movement of piston 11 of cylinder device 6A is suppressed. Under this condition, an effective length of cylinder device 6A, that is, the length from the pivot shaft 12 to pivot member 14 becomes fixed, and thus, due to the fixed condition of cylinder device 6A, the pivotal connection between torsion portion 4 and arm portion 3 through pivotal bearing 7 is suppressed any longer. That is, the rolling restricting function of the stabilizer 100 becomes ON.

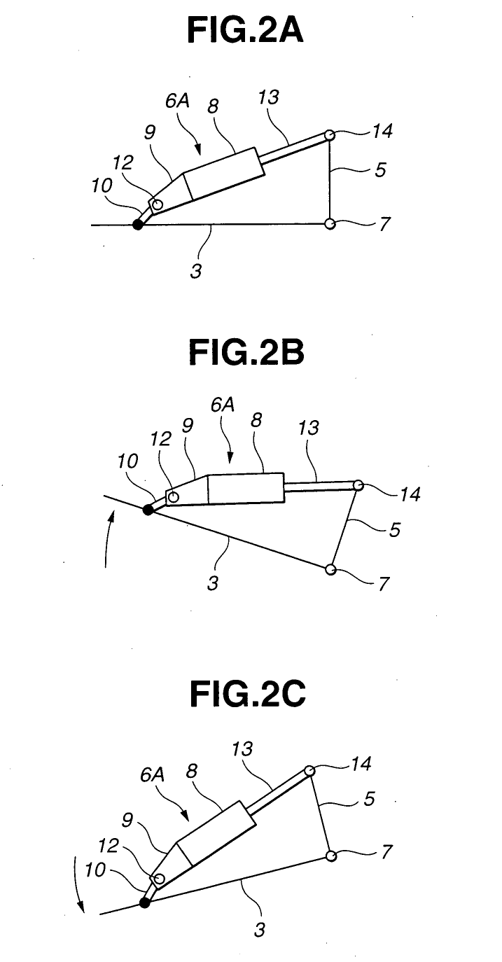

The above-mentioned operation will be clarified when referring to the illustrations of FIGS. 2A, 2B and 2C. These drawings are views taken from the direction of the arrow “F” of FIG. 1.

FIG. 2A shows a condition wherein both arm portion 2 and arm portion 3 are in their normal positions, FIG. 2B shows a condition wherein arm portion 2 and arm portion 3 are both displaced in the same direction in a clockwise direction, and FIG. 2C shows a condition wherein both arm portion 2 and arm portion 3 are both displaced in the same direction in a counterclockwise direction.

In all of the conditions shown by these drawings, there is produced no relative displacement about the axis of torsion portion 4 between arm portion 2 and arm portion 3, and thus, there is produced no relative displacement between case 8 of cylinder device 6A and piston 11 of the same. Accordingly, irrespective of ON/OFF operation of the Control system, the stabilizer 100 does not exhibit the rolling restricting function.

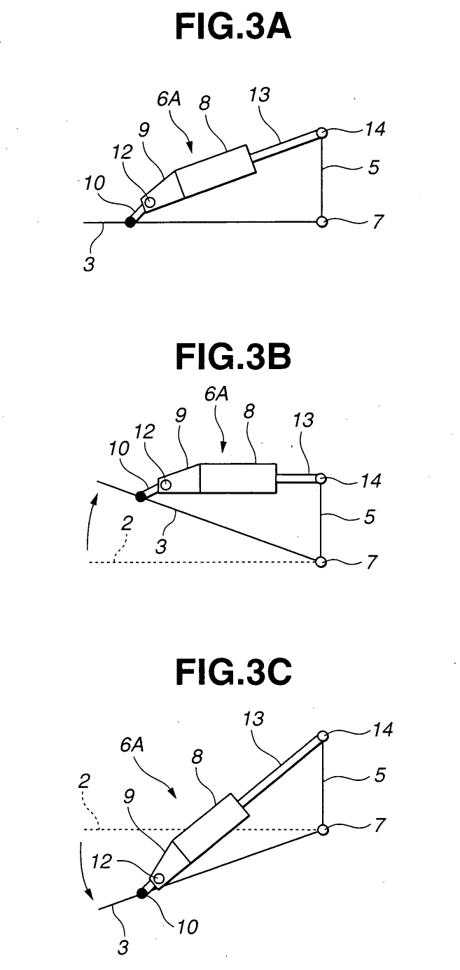

FIGS. 3A, 3B and 3C are also views taken from the direction of the arrow “F” of FIG. 1.

FIG. 3A shows a condition wherein both arm portion 2 and arm portion 3 are in their normal positions, FIG. 3B shows a condition wherein arm portion 3 is displaced in a clockwise direction about the axis of torsion portion 4 and the other arm portion 2 is in its normal position, and FIG. 3C shows a condition wherein arm portion 3 is displaced in a counterclockwise direction about the axis of torsion portion 4 and the other arm 2 is in its normal position.

In the condition of FIG. 3A, there is produced no relative displacement about the axis of torsion portion 4 between arm portion 2 and arm portion 3, and thus, there is produced no relative displacement between case 8 of cylinder device 6A and piston 11 of the same. Accordingly, irrespective of ON/OFF operation of the control system, the stabilizer does not exhibit the rolling restricting function.

In the conditions of FIGS. 3B and 3C, there is produced a relative displacement about the axis of torsion portion 4 between arm portion 2 and arm portion 3. That is, under cornering of the associated motor vehicle, the Control system is closed to make the rolling restricting function ON for restraining such relative displacement. While, when the vehicle is running straightly on a bumpy road, the control system is opened to make the rolling restricting function OFF for permitting such relative displacement.

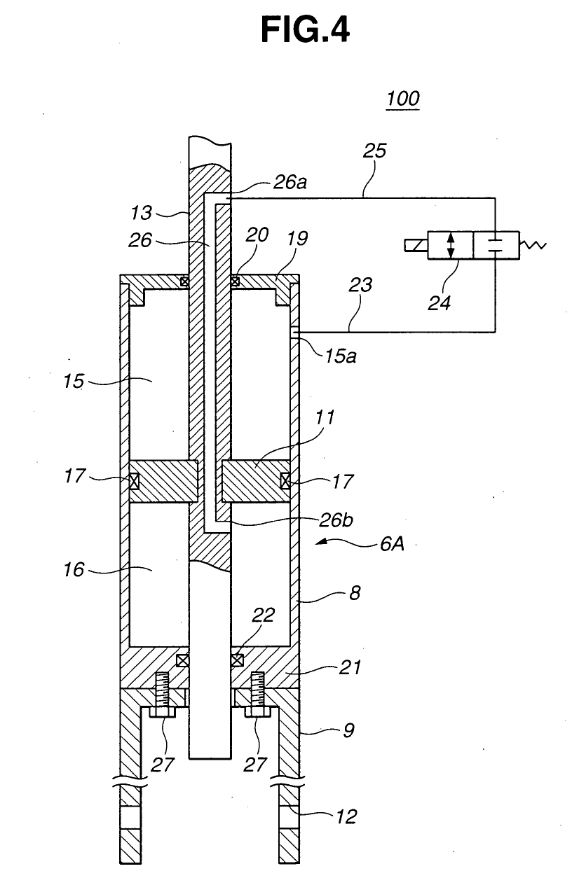

The control system incorporated with cylinder device 6A is shown in FIG. 4.

As is described hereinabove, cylinder device 6A generally comprises cylindrical case 8, piston 11 slidably received in case 8 through an oil seal 17, piston rod 13 connected to piston 11 to move therewith.

As shown, due to provision of piston 11, the interior of case 8 is divided into first and second work chambers 15 and 16. For the reason which will become apparent hereinafter, case 8 is formed with an opening 15a exposed to first work chamber 15.

Piston rod 13 has an upper portion that extends upward through an opening of an upper lid 19 fixed to case 8. For sealing piston rod 13 relative to upper lid 19, an oil seal 20 is provided by the opening of the lid 19, as shown. Piston rod 13 has further a lower portion that extends downward through an opening of a bottom wall 21 of case 9. An oil seal 22 is provided by the opening of the bottom wall 21. Bracket 9 is secured to bottom wall 21 through bolts 27.

As shown, piston rod 13 is formed with an axially extending passage 26 that has first and second openings 26a and 26b. In the illustrated condition, first opening 26a is exposed to the outside of cylindrical case 8 and second opening 26b is exposed to second work chamber 16 of case 8.

First and second work chambers 15 and 16 are connected through the control system which comprises a first passage 23 that extends from opening 15a, an electromagnetic ON/OFF valve 24 that has the other end of first passage 23 connected thereto, a second passage 25 that extends from the ON/OFF valve 24 to first opening 26a of passage 26 of piston rod 13. Thus, when piston rod 13 takes the illustrated position and ON/OFF valve 24 takes an open position (not the illustrated position), the two work chambers 15 and 16 are connected thereby smoothing movement of piston rod 13 in case 8.

That is, as is understood from the circuit of FIG. 4, even when, due to rolling of the associated motor vehicle, there is produced a relative displacement between the two arm portions 2 and 3 (see FIG. 1) about the axis of torsion portion 4 of antisway bar “AS”, the rolling restricting function of stabilizer 100 can be made ON or OFF by electromagnetic ON/OFF valve 24 at will irrespective of the degree of the relative displacement.

When ON/OFF valve 24 is opened, the hydraulic fluid in cylinder device 6A is permitted to flow freely between two work chambers 15 and 16 through the open circuit, and thus piston 11 is permitted to move freely in case 8 of cylinder device 6A. In this condition, torsion portion 4 and arm portion 3 of antisway bar “AS” are permitted to make a relative pivoting. That is, in this condition, the rolling restricting function of stabilizer 100 is OFF.

While, when ON/OFF valve 24 is closed, the flow of the fluid between two work chambers 15 and 16 is suppressed and thus movement of piston 11 in case 8 of cylinder device 6A is suppressed. Under this condition, torsion portion 4 and arm portion 3 of antisway bar “AS” are prevented from making the relative pivoting. That is, in this condition, the rolling restricting function of stabilizer 100 is ON.

It is to be noted that ON/OFF valve 24 has a so-called fail safe function. That is, when, due to some unexpected trouble, the electromagnet of valve 24 fails to be energized, valve 24 is forced to take the close position by the force of a biasing spring. That is, in such case, the rolling restricting function of stabilizer 100 is ON.

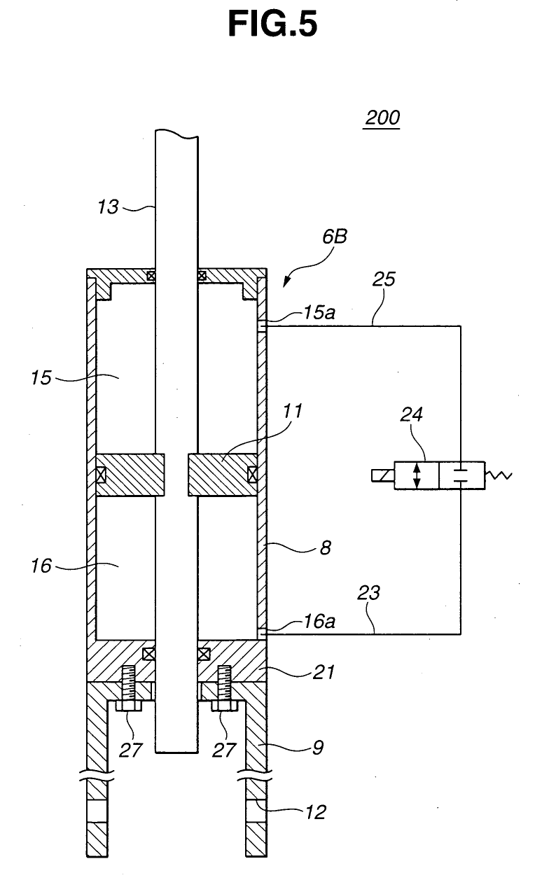

Referring to FIG. 5, there is shown a control system that is employed in a second embodiment 200 of the present invention.

That is, in the control system employed in the second embodiment 200, case 8 of cylinder device 8B has an opening 15a through which first work chamber 15 is connected to second passage 25 and an opening 16a through which second work chamber 16 is connected to first passage 23. That is, first and second work chambers 15 and 16 are connected through first and second passages 23 and 24 and ON/OFF valve 24, directly.

Since operation of this switch circuit is substantially the same as that of the above-mentioned first embodiment 100 of FIG. 4, explanation of the operation will be omitted.

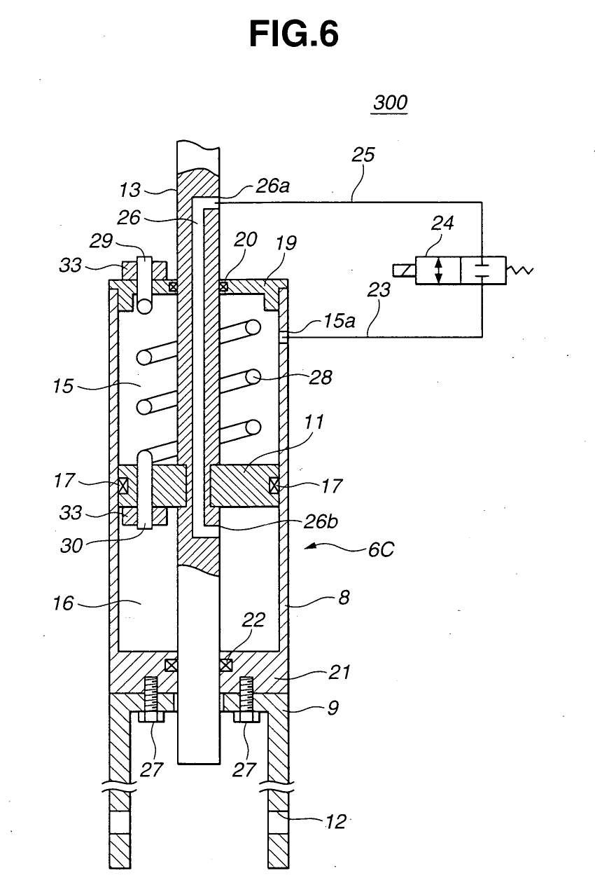

Referring to FIG. 6, there is shown a control system that is employed in a third embodiment 300 of the present invention.

As will be understood as the description proceeds, in this third embodiment 300, the rolling restricting function of stabilizer can be controlled to Low and High modes.

Since the switch circuit employed in this third embodiment 300 is similar to that of the above-mentioned first embodiment 100, only parts and portions which are different from those of the first embodiment 100 will be described in detail in the following. Substantially same parts and portions as those of the first embodiment 100 are denoted by the same numerals.

As is seen from FIG. 6, within first work chamber 15, there is installed a coil spring 28 that extends between upper lid 19 and piston 11. That is, upper and lower ends of coil spring 28 are fixed to upper lid 19 and piston 11 respectively.

More specifically, upper end of coil spring 28 has a straight threaded bolt part 29 passing through an opening of upper lid 19, and lower end of coil spring 28 has a straight threaded bolt part 30 passing through an opening of piston 11. The upper and lower threaded bolt parts 29 and 30 are engaged with respective nuts 33 for achieving the connection thereof with upper lid 19 and piston 11, as shown.

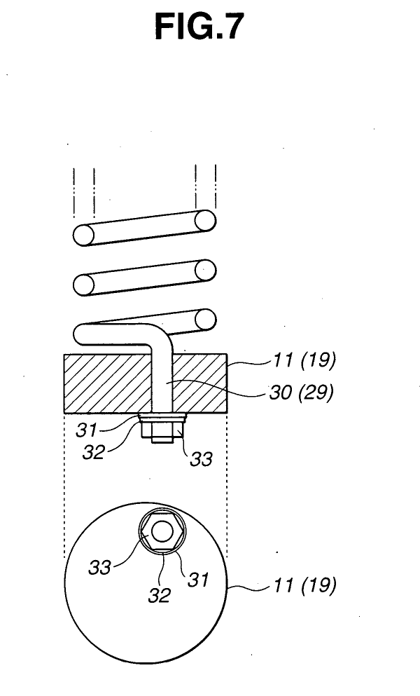

The detail of such bolt-and-nut connection will be well understood from FIG. 7 that shows the detail of the connection between the bolt part 30 and piston 11. As shown, an oil seal 31 and a spring seat 32 are further used for such connection.

Due to provision of coil spring 28 installed in the above-mentioned manner, piston 11 can be biased toward upper lid 19 or bottom wall 21 depending on the position of piston 11. That is, when first work chamber 15 is fed with hydraulic fluid, piston 11 is forced to move downward toward bottom wall 21 expanding coil spring 28. Thus, in this case, coil spring 28 functions to bias piston 11 upward toward upper lid 19, while when second work chamber 16 is fed with the fluid, piston 11 is forced to move upward toward upper lid 19 compressing coil spring 28. Thus, in this case, coil spring 28 functions to bias piston 11 downward toward bottom wall 21.

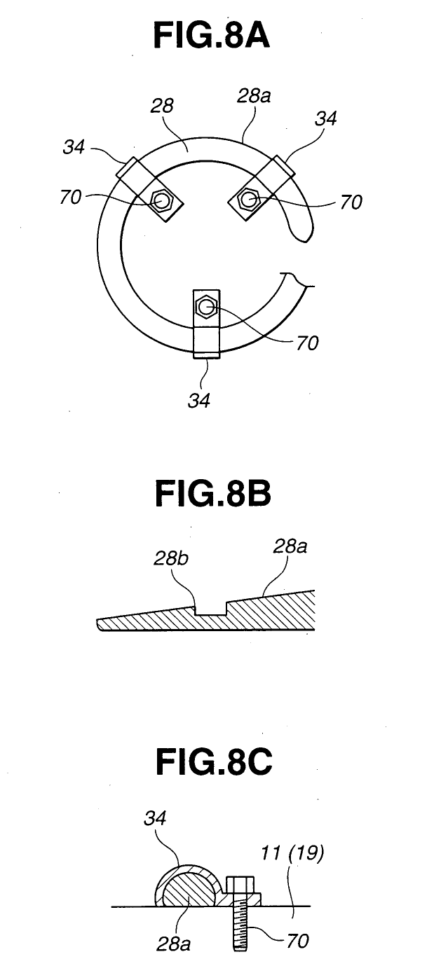

FIGS. 8A, 8B and 8C show another way of connecting coil spring 28 to upper lid 19 or piston 11. As is seen from these drawings, each turned end portion 28a of coil spring 28 is shaped to have a flat base surface that is perpendicular to an axis of coil spring 28. The turned end portion has three cut recesses 28b for neatly receiving arm portions of respective clamps 34 that are secured to piston 11 (or upper lid 19) through respective bolts 70.

If desired, coil spring 28 may be installed in second work chamber 16 not in first work chamber 15, and furthermore, if desired, respective coil springs 28 may be installed in first and second work chambers 15 and 16.

As is understood from the circuit of FIG. 6, even when, due to rolling of the associated motor vehicle, there is produce a relative displacement between the two arm portions 2 and 3 (see FIG. 1) about the axis of torsion portion 4 of antisway bar “AS”, the rolling restricting function of stabilizer 300 can be controlled to Low or High mode at will by electromagnetic ON/OFF valve 24 irrespective of the degree of the relative displacement.

When ON/OFF valve 24 is opened, the hydraulic fluid is permitted to flow freely between two work chambers 15 and 16 through the open circuit, and thus piston 11 is permitted to move freely in case 8 of cylinder device 6C. In this condition, torsion portion 4 and arm portion 3 of antisway bar “AS” are permitted to make a relative pivoting through coil spring 28 and link lever 5. Under this condition, a resistance induced by the relative displacement between torsion portion 4 and arm portion 3 is a tandem combination of a resistance induced by the torsional rigidity of torsion portion 4 and a resistance induced by coil spring 28 through link lever 5 about the axis of torsion portion 4, and thus, the resistance induced by the relative displacement between torsion portion 4 and arm portion 3 is smaller than a resistance induced by only the torsional rigidity of torsion portion 4. Thus, under this condition, the rolling restricting function of stabilizer 300 is controlled to Low mode.

While, when ON/OFF valve 24 is closed, the flow of the fluid between two work chambers 15 and 16 is suppressed and thus movement of piston 11 in case 8 of cylinder device 6C is suppressed. Under this condition, torsion portion 4 and arm portion 3 of antisway bar “AS” are prevented from making the relative pivoting, and thus, the rolling restricting function of stabilizer 300 is controlled to High mode.

In the arrangement of the third embodiment 300 of FIG. 6, a high drive stability of an associated motor vehicle is obtained especially when the vehicle is subjected to a sharp steering to avoid an obstruction on the road and then subjected to a counter-steering for recovering the posture of the vehicle. During this, a marked centrifugal force is applied to the vehicle body. That is, if switching from Low mode to High mode is made timely during such steering of the vehicle, a high and much effective rolling restricting operation is exhibited by the stabilizer.

It is to be noted that the control system of FIG. 6 has a fail-safe function. That is, when, due to some unexpected trouble, the electromagnet of valve 24 fails to operate, valve 24 is forced to take the close position by the force of a biasing spring. Thus, in such case, the rolling restriction function of stabilizer 300 takes High mode. Of course, a reversed operation viz., Low mode may be adopted in such unexpected trouble. That is, in this case, valve 24 is forced to take the open position by the force of the biasing spring.

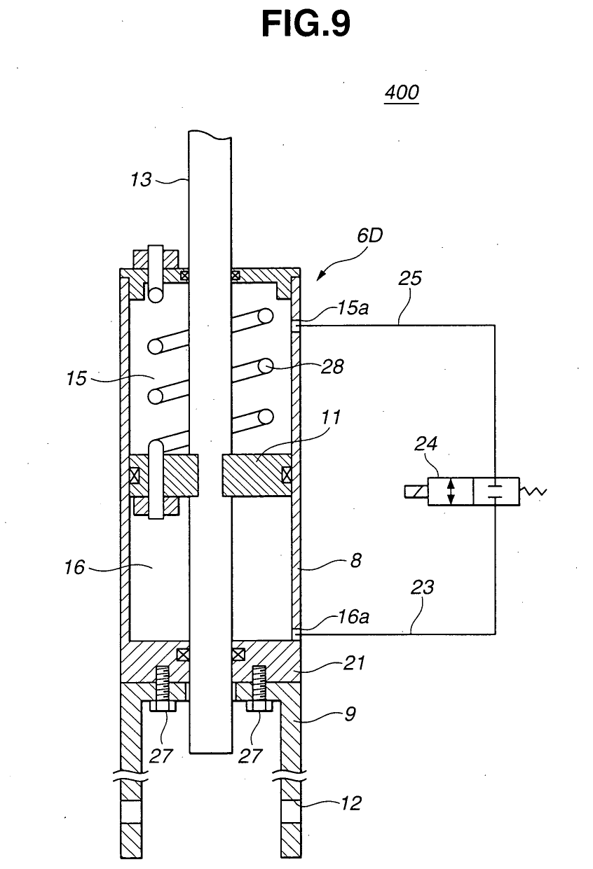

Referring to FIG. 9, there is shown a control system that is employed in a fourth embodiment 400 of the present invention.

Also in this fourth embodiment 400, the rolling restricting function of stabilizer can be controlled to Low and High modes.

Since the switch circuit of the fourth embodiment 400 is similar to that of the second embodiment 200 of FIG. 5, only parts or portions which are different from those of the second embodiment 200 will be described in detail in the following. Substantially same parts and portions as those of the second embodiment 200 are denoted by the same numerals.

As is seen from FIG. 9, within first work chamber 15 of cylinder device 6D, there is installed a coil spring 28 of which upper and lower ends are connected to upper lid 19 and piston 11 in the above-mentioned manner.

Since operation of this switch circuit is substantially the same as that of the above-mentioned third embodiment 300 of FIG. 6, explanation of the operation will be omitted.

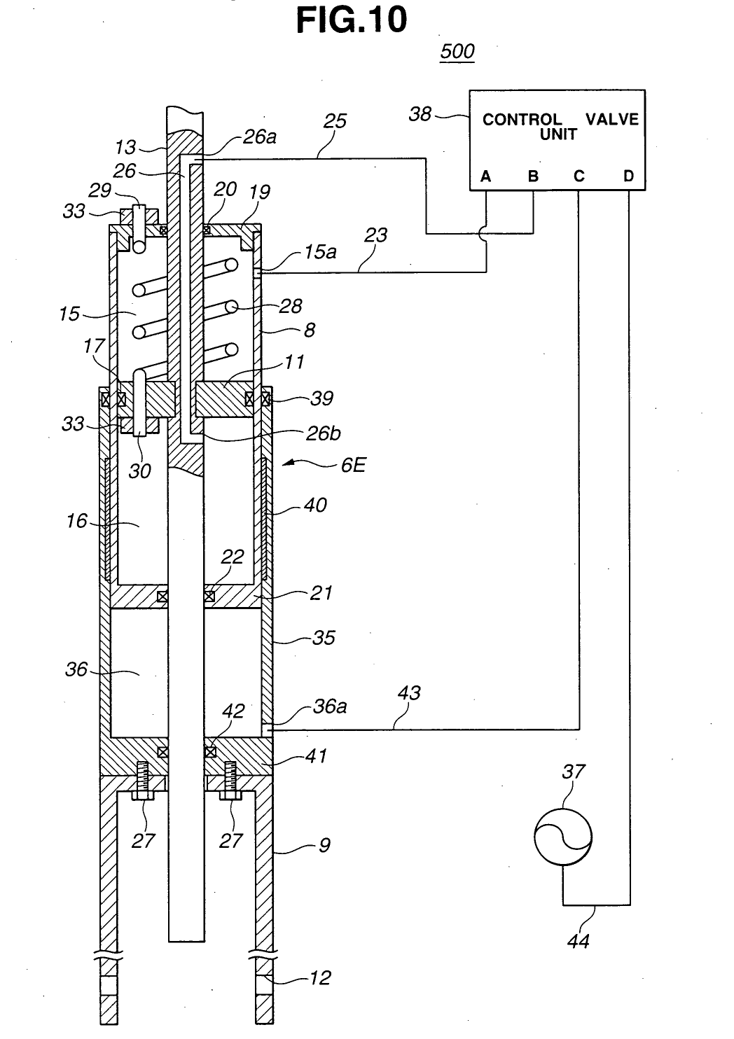

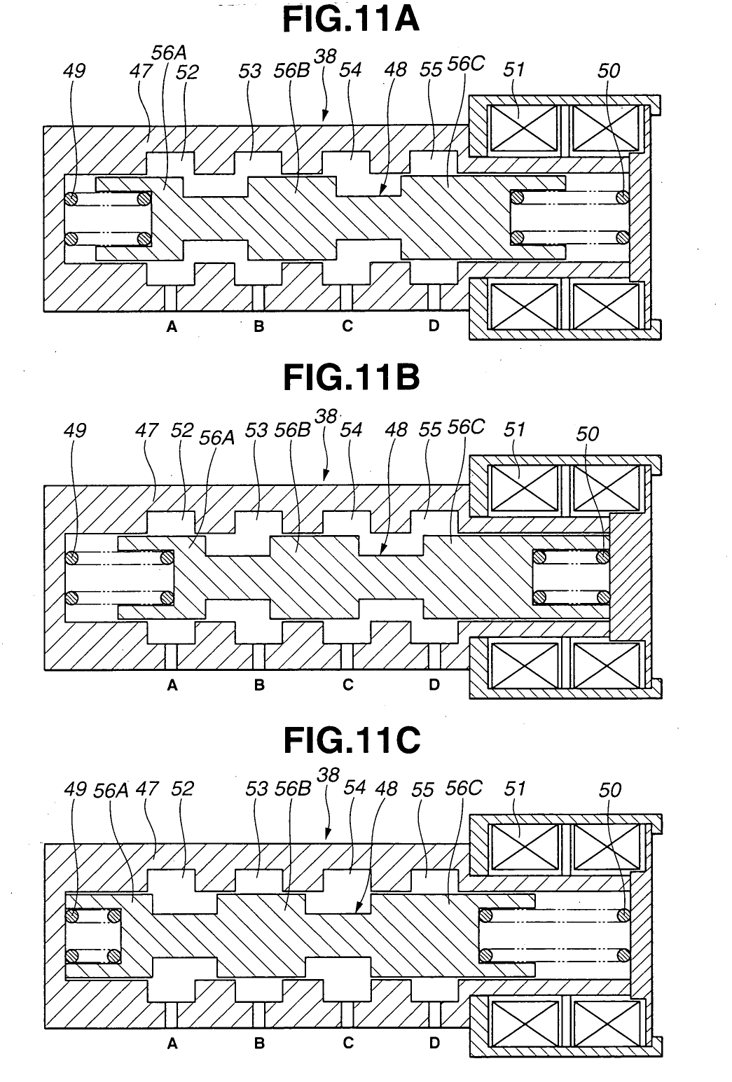

Referring to FIGS. 10, 11A, 11B and 11C, particularly FIG. 10, there is shown a control system that is employed in a fifth embodiment 500 of the present invention.

As will be understood as the description proceeds, in this fifth embodiment 500, the rolling restricting function of stabilizer can be controlled to Off, Low and High modes.

Since the switch circuit employed in the fifth embodiment 500 is similar to that of the above-mentioned third embodiment 300 of FIG. 6, only parts and portions which are different from those of the third embodiment 300 will be described in detail in the following. Substantially same parts and portions as those of the third embodiment 300 are denoted by the same numerals.

As is seen from FIG. 10, an outer cylindrical case 35 is further provided in which cylindrical case 8 is slidably received. For achieving a hermetical sealing between two cases 8 and 35, an oil seal 39 is provided to an upper part of outer case 35, and for achieving a smoothed axial movement of case 8 relative to outer case 35, a slide bearing 40 is provided to outer case 35.

Due to the telescopic connection between two cases 8 and 35, there is produced a third work chamber 36 through which the lower portion of piston rod 13 passes. As shown, third work chamber 36 is defined between bottom wall 21 of cylindrical case 8 and a bottom wall 41 of outer case 35. Bottom wall 41 is formed with an opening through which the lower portion of piston rod 13 passes downward. For assuring a sealing between piston rod 13 and bottom wall 41, an oil seal 42 is provided to the bottom wall 41, as shown. Bracket 9 is secured to bottom wall 41 through bolts 27. Outer core 35 is formed with an opening 36a exposed to third work chamber 36.

In place of electromagnetic ON/OFF valve 24 employed in the above-mentioned first, second, third and fourth embodiments 100, 200, 300 and 400, an electromagnetic control valve unit 38 is employed in this fifth embodiment 500.

This control valve unit 38 has four ports, which are a port “A” to which opening 15a of first work chamber 15 is connected through first passage 23, a port “B” to which first opening 26a passage 26 of piston rod 13 is connected through second passage 25, a port “C” to which opening 36a of third work chamber 36 is connected through a third passage 43 and a port “D” to which an accumulator 37 is connected through a fourth passage 44. As will be clarified as the description proceeds, third work chamber 36 and accumulator 37 are connected through third passage 43, port “C”, a selectable passage defined by control valve unit 38, port “D” and fourth passage 44.

The detail of electromagnetic control valve unit 38 is shown in FIG. 11A.

As shown, valve unit 38 generally comprises a cylindrical case 47, a spool 48 slidably received in case 47, two reaction springs 49 and 50 for biasing spool 48 toward a balanced position and an electromagnetic actuator 51 for moving spool 48 against the biasing force of reaction springs 49 and 50 when energized.

Cylindrical case 47 has therein an elongate bore including equally spaced four (viz., first, second, third and fourth) grooves 52, 53, 54 and 55 that are merged with ports “A” “B”, “C” and “D” respectively.

Spool 48 has first, second and third lands 56A, 56B and 56C and is biased by the two (viz., first and second) reaction springs 49 and 50 to have a neutral position as shown by FIG. 11A. That is, in this neutral position, ports “A” and “B” are connected, and ports “C” and “D” are disconnected.

When actuator 51 is energized in a first manner, spool 48 is moved rightward to take a rightmost position as shown in FIG. 11B against the force of spring 50. In this case, ports “A” and “B” are disconnected and ports “C” and “D” are connected, as shown.

While, when actuator 51 is energized in a second manner, spool 48 is moved leftward to take a leftmost position as shown in Fig. 11C against the force of spring 49. In this case, ports “A” and “B” are disconnected and ports “C” and “D” are also disconnected.

Even when there is produced a relative displacement between arm portions 2 and 3 about the axis of torsion portion 4 (see FIG. 1) because of rolling of the associated motor vehicle, the rolling restricting function of stabilizer 500 can be controlled to Off, Low or High mode by suitably operating the control system of FIG. 10, which will be clarified from the following description.

When, upon energization of actuator 51 in the first manner, valve unit 38 assumes the condition of FIG. 11B, first and second work chambers 15 and 16 (see FIG. 10) are disconnected suppressing free flow of the hydraulic fluid therebetween, and third work chamber 36 is connected to accumulator 37 permitting free flow of the hydraulic fluid therebetween. In this case, piston 11 is suppressed from making a free movement in case 8 of cylinder device 6E and case 8 is permitted to make a free movement in outer case 35. Thus, torsion portion 4 and arm portion 3 of antisway bar “AS” are permitted to make a relative pivoting. That is, in this condition, the rolling restricting function of stabilizer 500 has Off mode.

While, due to de-energization of actuator 51, valve unit 38 assumes the condition of FIG. 11A, first and second work chambers 15 and 16 (see FIG. 10) are connected permitting free flow of the hydraulic fluid therebetween, and third work chamber 36 is isolated from accumulator 37 suppressing free low of the hydraulic fluid therebetween. In this case, piston 11 is permitted to make a free movement in case 8 of cylinder device 6E and case 8 is suppressed from making a free movement in outer case 35. Under this condition, pivotal connection between torsion portion 4 and arm portion 3 is made through coil spring 28 and link lever 5. Thus, in this case, a resistance induced by the relative displacement between torsion portion 4 and arm portion 3 is a tandem combination of a resistance induced by the torsional rigidity of torsion portion 4 and a resistance induced by coil spring 28 through link lever 5 about the axis of torsion portion 4, and thus, the resistance induced by the relative displacement between torsion portion 4 and arm portion 3 is smaller than a resistance induced by only the torsional rigidity of torsion portion 4. Thus, under this condition, the rolling restricting function of stabilizer 500 has Low mode.

While, upon energization of actuator 51 in the second manner, valve unit 38 assumes the condition of FIG. 11C, first and second work chambers 15 and 16 (see FIG. 10) are disconnected suppressing free flow of the hydraulic fluid therebetween, and third work chamber 36 is isolated from accumulator 37 suppressing free flow of the hydraulic fluid therebetween. In this case, piston 11 is suppressed from making a free movement in case 8 of cylinder device 6E and case 8 is suppressed from making a free movement in outer case 35. Thus, the actual length of cylinder device 6E becomes fixed, and thus, torsion portion 4 and arm portion 3 are prevented from making a relative pivoting through link lever 5. That is, in this condition, the rolling restricting function of stabilizer 500 has High mode.

Thus, in stabilizer 500 of the third embodiment, not only ON/OFF switching for the rolling restricting function that is needed when an associated motor vehicle runs on bumpy/paved road, but also switching between Low and High modes for the rolling restricting function is achieved.

In the following, modifications will be briefly described.

If desired, additional work chamber, that is, a fourth work chamber may be provided. In this case, further mode can be provided in addition to the above-mentioned Off, Low and High modes.

If desired, coil springs may be installed in second and third work chambers 16 and 36. In this case, the Off, Low and High modes of the rolling restricting function are much finely controlled. By suitably selecting the spring constant of each coil spring, much desired control for the rolling restricting function is achieved.

If desired, the control system may be applied also to a junction portion between torsion portion 4 and the other arm portion 2. In this case, it is preferable to employ different types of cylinder devices for respective switch circuits.

If desired, a steered angle detecting means may be provided for detecting a steered angle of steered road wheels. That is, in accordance with information signal from the detecting means, ON/OFF valve 24 or control valve unit 38 is controlled. In this modification, ON/OFF section for the rolling restricting function or Off, Low and High mode selection for the function can be controlled in accordance the steered angle of the steered road wheels. Furthermore, in accordance with the surface condition of the road and running condition of the vehicle, the rolling restricting function can be automatically controlled.

In first, second, third and fourth embodiments 100, 200, 300 and 400, electromagnetic ON/OFF valve 24 is used as an element of the ON/Off switch circuit. If desired, in place of such valve 24, a valve that can take a half-open position or continuously changeable positions may be used. When such valve is used, the following advantageous operation is expected. That is, when, with the two arm portions 2 and 3 showing a relative displacement, Off instruction is applied to the rolling restricting function, the rolling restricting function is gradually changed to Off mode, which suppresses a sudden change of posture of the associated motor vehicle.

If desired, passages 23, 25 43 and 44 or some of them may have orifices. Under flowing of the hydraulic fluid in the passages, a damping force is produced by stabilizer. Thus, when, with two arm portions 2 and 3 showing a relative displacement, the rolling restricting function is turned OFF, movement of piston 11 of cylinder device is slowed and thus sudden change of posture of the vehicle is suppressed.

If desired, in place of the above-mentioned cylinder devices 6A to 6E, other types of cylinder devices may be used so long as they has means for controlling the actual length.

The entire contents of Japanese Patent Application 2003-419688 filed Dec. 17, 2003 are incorporated herein by reference.

Although the invention has been described above with reference to the embodiments of the invention, the invention is not limited to such embodiments as described above. Various modifications and variations of such embodiments may be carried out by those skilled in the art, in light of the above description.

1. An automotive stabilizer incorporated with a suspension system, comprising:
an antisway bar adapted to extend transversely relative to a vehicle body, the antisway bar including a pair of arm portions and a torsion portion extending between the arm portions;
a pivot member pivotally connected to a junction portion between the torsion portion and selected one of the arm portions;
a link lever extending from the pivot member;
a cylinder device including a cylindrical case and a piston slidably received in the cylindrical case, the cylindrical case being connected to one of the selected arm portion and the link lever and the piston being connected to the other of the selected arm portion and the link lever; and
a control system that restricts the movement of the piston in the cylindrical case when actuated.

2. An automotive stabilizer as claimed in claim 1, in which the control system comprises:
first and second work chambers defined in the cylindrical case and separated by the piston; and
an ON/OFF switch circuit that is able to selectively provide an open condition to communicate the first and second work chambers and a closed condition to isolate the first and second work chambers.

3. An automotive stabilizer as claimed in claim 2, in which the ON/OFF switch circuit comprises:
an electromagnetic valve;
a first passage extending between the first work chamber and the electromagnetic valve; and
a second passage extending between the second work chamber and the electromagnetic valve.

4. An automotive stabilizer as claimed in claim 3, in which the second passage includes a passage formed in a piston rod of the piston, the passage of the piston rod having a first opening that is connected to the electromagnetic valve and a second opening that is exposed to the second work chamber.

5. An automotive stabilizer as claimed in claim 3, in which the electromagnetic valve is of an ON/OFF type that assumes a close position when de-energized and an open position when energized.

6. An automotive stabilizer as claimed in claim 2, in which at least one of the first and second work chambers has a coil spring installed therein, the coil spring having one end portion connected to the cylindrical case and the other end portion connected to the piston.

7. An automotive stabilizer as claimed in claim 6, in which each of the end portions of the coil spring has a threaded bolt part that is connected to the corresponding part by a nut.

8. An automotive stabilizer as claimed in claim 7, in which the connection between the threaded bolt part and the nut is achieved with an interposition of an oil seal and a washer therebetween.

9. An automotive stabilizer as claimed in claim 6, in which each of the end portions of the coil spring is connected to the corresponding part through a clamp.

10. An automotive stabilizer as claimed in claim 9, in which the cramp has one end bolted to the corresponding part and the other end grasping the end portion of the coil spring.

11. An automotive stabilizer as claimed in claim 10, in which each of the end portions of the coil spring has a cut recess into which the end portion of the coil spring is received.

12. An automotive stabilizer as claimed in claim 1, in which the control system comprises:
first and second work chambers defined in the cylindrical case and separated by the piston;
an outer cylindrical case that is slidably disposed on the cylindrical case to define therebetween a third work chamber;
an accumulator; and
an electromagnetic control valve unit that is able to provide three operation conditions which are a first condition wherein the first and second work chambers are connected and the third work chamber and the accumulator are disconnected, a second condition wherein the first and second word chambers are disconnected and the third work chamber and the accumulator are connected, and a third condition wherein the first and second work chambers are disconnected and the third work chamber and the accumulator are disconnected.

13. An automotive stabilizer as claimed in claim 12, in which the electromagnetic control valve unit comprises:
a cylindrical case having an elongate bore including first, second, third and fourth grooves which are connected to first, second and third work chambers and the accumulator respectively;
a spool slidably received in the elongate bore of the cylindrical case, the spool having first, second and third lands;
a first reaction spring compressed between one end of the elongate bore and one end of the spool to bias the spool toward the other end of the elongate bore;
a second reaction spring compressed between the other end of the elongate bore and the other end of the spool to bias the spook toward said one end of the elongate bore; and
an electromagnetic actuator that shifts the spool to given s positions against the first and second springs when energized.

14. An automotive stabilizer as claimed in claim 1, further comprising:
a steered angle detecting device that detects a steered angle of steered road wheels of the vehicle; and
a control means that controls the restricting operation of the control system in accordance with the steered angle detected by the steered angle detecting device.

15. An automotive stabilizer incorporated with a suspension system, comprising:
an antisway bar adapted to extend transversely relative to a vehicle body, the antisway bar including a pair of arm portions and a torsion portion extending between the arm portions;
a pivot member pivotally connected to a junction portion between the torsion portion and selected one of the arm portions;
a link lever extending from the pivot member;
a cylinder device including a cylindrical case, a piston slidably received in the cylindrical case and a piston rod extending from the piston to the outside of the cylindrical case, the cylindrical case having therein first and second work chambers that are isolated by the piston;
a first pivot member through which the cylindrical case of the cylinder device is pivotally connected to a part of the selected arm portion;
a second pivot member through which the piston rod is pivotally connected to the link lever; and
an ON/OFF switch circuit that is able to selectively provide an opening condition to communicate the first and second work chambers and a closed condition to isolate the first and second work chambers.

16. An automotive stabilizer as claimed in claim 15, in which the first work chamber has a coil spring installed therein, the coil spring having one end connected to one axial end of the cylindrical case and the other end connected to the piston.

17. An automotive stabilizer incorporated with a suspension system, comprising:
an antisway bar adapted to extend transversely relative to a vehicle body, the antisway bar including a pair of arm portions and a torsion portion extending between the arm portions;
a pivot member pivotally connected to a junction portion between the torsion portion and selected one of the arm portions;
a link lever extending from the pivot member;
a cylinder device including a cylindrical case, a piston slidably received in the cylindrical case and a piston rod extending from the piston to the outside of the cylindrical case, the cylindrical case having therein first and second work chambers that are isolated by the piston;
an outer cylindrical case slidably disposed on the cylindrical case to define between a third work chamber;
an accumulator;
a first pivot member through which the outer cylindrical case is pivotally connected to a part of the selected arm portion;
a second pivot member through which the piston rod is pivotally connected to the link lever; and
an electromagnetic control valve unit that is able to provide three operation conditions which are a first condition wherein the first and second work chambers are connected and the third work chamber and the accumulator are disconnected, a second condition wherein the first and second word chambers are disconnected and the third work chamber and the accumulator are connected, and a third condition wherein the first and second work chambers are disconnected and the third work chamber and the accumulator are disconnected.
